(19) United States
(12) Patent Application Publication
(10) Pub. No.: US 2013/0302881 A1
(43) Pub. Date: Nov. 14, 2013

(54) METHOD FOR PRODUCING REFINED VEGETABLE OIL

(71) Applicants: Krishnadath Bhaggan, AZ Wormerveer (NL); Jeanine Luvelle Werleman, AZ Wormerveer (NL)

(72) Inventors: Krishnadath Bhaggan, AZ Wormerveer (NL); Jeanine Luvelle Werleman, AZ Wormerveer (NL)

(73) Assignee: LODER CROKLAAN B.V., AZ Wormerveer (NL)

(21) Appl. No.: 13/988,052

(22) PCT Filed: Oct. 12, 2011
(86) PCT No.: PCT/EP11/67816

§ 371 Date: Jul. 29, 2013

(30) Foreign Application Priority Data
Nov. 19, 2010 (GB) 1019639.2

(51) Int. Cl. C11B 3/04; C11B 3/00

(52) U.S. Cl. CPC C11B 3/04; C11B 3/003
USPC 435/271; 554/204; 554/190; 554/1

(57) ABSTRACT

A method of producing a refined, bleached and deodorised vegetable oil comprises degumming a vegetable oil, bleaching the degummed oil and deodorising the bleached oil, wherein the degumming, bleaching and deodorising conditions are selected to reduce the content of 3-chloropropane-1,2-diol and esters thereof in the deodorised oil to less than 8 ppm.

This invention relates to a method, in particular to a method for producing a refined vegetable oil.

http://www.ilsi.org/Europe/Publications/Final%20version%203%20MCPD%20esters.p df discloses that certain foodstuffs may contain 3-chloropropane-1,2-diol (3-MCPD) and esters. Esters are typically esters of fatty acids, including C12-C24 straight chain, saturated or unsaturated carboxylic acids.

There is a need to reduce or eliminate the presence of 3-MCPD and/or its esters in vegetable oils and foodstuffs containing them.

According to the invention, there is provided a method of producing a refined, bleached and deodorised vegetable oil which comprises degumming a vegetable oil, bleaching the degummed oil and deodorising the bleached oil, wherein the degumming, bleaching and deodorising conditions are selected to reduce the content of 3-chloropropane-1,2-diol and esters thereof in the deodorised oil to less than 8 ppm.

In another aspect, the invention provides a method of reducing the content of 3-chloropropane-1,2-diol and esters thereof of in a refined, bleached and deodorised vegetable oil, which comprises degumming a vegetable oil, bleaching the degummed oil and deodorising the bleached oil, wherein at least one of the degumming, bleaching and deodorising conditions are selected to reduce the content of 3-chloropropane-1,2-diol and esters thereof in the deodorised oil to less than 8 ppm.

The invention also provides a non-interesterified, refined, bleached, degummed and deodorised palm oil, or a fraction thereof, having a content of 3-chloropropane-1,2-diol and esters thereof of less than 8 ppm.

In another aspect, the invention provides a method for reducing the formation of 3-chloropropane-1,2-diol and esters thereof comprising:

degumming a vegetable oil using a degumming agent comprising citric acid, bleaching the degummed oil in the presence of a natural bleaching agent, and deodorising the bleached oil at a temperature of less than 260° C.

A further aspect of the invention is a process for reducing the levels of 3-chloropropane-1,2-diol and esters thereof in a vegetable oil, such as palm oil, which comprises treating the oil with a base.

Esters of 3-chloropropane-1,2-diol are typically esters of fatty acids, including C12-C24 straight chain saturated or unsaturated carboxylic acids.

The vegetable oil is typically an edible oil. Preferably, the vegetable oil comprises or is palm oil. Palm oil, fractions of palm oil or blends of palm oil and/or its fractions may be used in the invention. Oils derived from palm include palm oil, palm oil stearin, palm olein, palm kernel oil, palm kernel stearin and palm kernel olein and mixtures thereof.

The degumming is preferably carried out using a degumming agent comprising citric acid. More preferably, the degumming agent comprises a mixture of citric acid and phosphoric acid. The amount of phosphoric acid preferably ranges from 0 to 50% by weight based on total citric and phosphoric acids.

Preferably, deodorisation is carried out at a temperature of less than 260° C., more preferably at a temperature of from 180° C. to 255° C., even more preferably from 200° C. to 250° C. General methods and apparatus for deodorising vegetable oils are well-known to those skilled in the art.

Bleaching is preferably carried out using a natural, non-activated bleaching agent. The bleaching agent may comprise a mixture of a natural, non-activated bleaching agent and optionally an acid activated bleaching earth in an amount of up to75% by weight of the total weight of bleaching agent.

Natural, non-activated bleaching agents are generally minerals occurring in nature that have not been chemically modified or treated, for example by activation with acid or alkali.

Preferred natural non-activated bleaching agents are clays, such as clays that have an intergrowth of two or more materials. More preferably, the natural non-activated bleaching agents are based on an intergrowth of hormite and smectite minerals. Smectite clays include clays such as montmorillonite and bentonite. They have a layered or plate-like structure and are characterized by substitutions of metal ions within their structure, and are therefore electrically unbalanced. Hormite or attapulgite is a magnesium aluminium silicate clay of very fine particle size with a chain instead of a sheet structure. Natural non-activated bleaching agents that comprise an intergrowth of hormite and smectite minerals may be intermediate in structure between that of bentonite and attapulgite, with lamellae and tubules forming a three dimensional, porous network.

Therefore, in one preferred embodiment, the method comprises:
degumming a vegetable oil using a degumming agent comprising citric acid, optionally together with phosphoric acid,
bleaching the degummed oil in the presence of a natural, non-activated bleaching agent, and
deodorising the bleached oil at a temperature of less than 260° C.

The content of 3-chloropropane-1,2-diol and esters thereof in the deodorised oil produced by the methods and process of the invention is preferably reduced to less than 6 ppm, such as less than 5 ppm, or less than 4 ppm, or less than 3 ppm, or less than 2 ppm.

Levels of 3-chloropropane-1,2-diol and esters thereof in the oils can be determined by the GC-MS method described in DGF Standard Methods at http://www.dgfett.de/methods/c-iii 18%20 09 e14.pdf.

Optionally, the oil is interesterified as part of the method. Interesterification may contribute to reducing the levels of 3-chloropropane-1,2-diol and esters thereof. The interesterification may be carried out in the presence of a base, such as sodium methoxide.

In another embodiment, the method comprises:
degumming a vegetable oil using a degumming agent comprising citric acid, optionally together with phosphoric acid,
bleaching the degummed oil, preferably in the presence of a natural, non-activated bleaching agent, and
deodorising the bleached oil at a temperature of less than 260° C., wherein the oil is interesterified.

The method may comprise a step of treating the oil with a base, such as sodium hydroxide or sodium methoxide, to reduce the levels of 3-chloropropane-1,2-diol and esters thereof.

In another aspect, therefore, the invention provides a process for reducing the levels of 3-chloropropane-1,2-diol and esters thereof in a vegetable oil, such as palm oil, which comprises treating the oil with a base. Suitable bases include sodium hydroxide and sodium methoxide. The oil produced by this process may be treated in the bleaching and/or deodorising steps of the methods of the invention i.e., bleaching the oil and/or deodorising the bleached oil, wherein the bleaching and/or deodorising conditions are selected to reduce the content of 3-chloropropane-1,2-diol and esters thereof in the deodorised oil to less than 8 ppm, preferably reduced to less than 6 ppm, such as less than 5 ppm, or less than 4 ppm, or less than 3 ppm, or less than 2 ppm.

In a further aspect the invention provides a process for reducing the levels of 3-chloropropane-1,2-diol and esters thereof in a vegetable oil, such as palm oil, which comprises treating the oil with an enzyme. Suitable enzymes are lipases, for example Lipase G (from Pennicilium camembertii). The oil produced by this process may be treated in the bleaching and/or deodorising steps of the methods of the invention i.e., bleaching the oil and/or deodorising the bleached oil, wherein the bleaching and/or deodorising conditions are selected to reduce the content of 3-chloropropane-1,2-diol and esters thereof in the deodorised oil to less than 8 ppm preferably reduced to less than 6 ppm, such as less than 5 ppm, or less than 4 ppm, or less than 3 ppm, or less than 2 ppm.

The following non-limiting examples illustrate the invention and do not limit its scope in any way. In the examples and throughout this specification, all percentages, parts and ratios are by weight unless indicated otherwise.

### EXAMPLES

### Example 1

Crude palm oil is physically refined using standard refining conditions to obtain RBD (R=refined; B=bleached; D=deodorized) palm oil (PO). The RBD PO contains 3-MCPD esters at level of higher than 10 ppm.

1200 gram of RBD PO is treated with 0.07% (wt) NaOMe (sodium methoxide) at 110° C. and reduced pressure (<2 mbar), for 30 min. After this, water is added to the reaction mixture and any soap formed during the treatment is washed out. The almost soap-free oil is then bleached using standard bleaching conditions (1-1.5% bleaching earth at 90° C.) and finally deodorized at 200° C. for 4 hrs. In the refined treated PO the level 3-MCPD esters is reduced to below 2 ppm.

### Example 2

1 kg of Palm Olein (POf IV 64; 16.8 ppm 3-MCPD's) is heated to 110° C. while stirring at average speed. The oil is then dried by applying vacuum and 0.1% (w/w) of NaOCH₃ is added. The obtained reaction mixture is stirred under vacuum for an additional 30 minutes and the NaOCH₃ is deactivated by adding citric acid. The treated oil is further refined by means of standard refining process. The deodorization is carried out at lower temperature (180° C.-210° C.).

By this treatment about 75% of the 3-MCPD esters are reduced to give a level of 2 ppm

### Example 3

### Refining of cPO—Effect of Type of Acid During Degumming

cPO (crude Palm Oil) is physically refined according to the following conditions:

1 kg of cPO is heated to 105° C. and 0.08% (w/w) of acid is added and stirred for 15 minutes at atmospheric pressure. After this, bleaching earth is added and the suspension is stirred under 100-250 mbar for 30 minutes. Hereafter, the oil is filtered and deodorized at 255° C. for 4 hrs.

Acid used for the degumming step:
75% H₃PO₄ solutions (Acid A)
50% Citric acid solution (Acid B)

By using Acid B in the degumming step a reduction of formation of 14% of 3-MCPD esters is achieved (7.9 ppm 3-MCPD's) instead of using Acid A (9 ppm 3-MCPD's).

### Example 4

### Reduction of 3-MCPD Esters by Enzymatic Treatment

To 1 kg of Palm olein (POf IV 64; 16.7 ppm 3-MCPD's) is added 25% (w/w) of demineralized water and the temperature of the obtained emulsion is set to 40° C. To this emulsion is added 0.05% (w/w) of Lipase G (Pennicilium camembertii) and the mixture is stirred for 24 hours. After this the temperature is increased to 80° C. in order to deactivate the enzyme. The reaction mixture is settled and the water phase discharged. The oil phase is washed with demineralized water in order to remove residual enzyme and dried after wards by applying vacuum.

The dried oil is further refined according to standard conditions. The deodorization is carried out at lower temperature (200° C., 8 hours).

By this process the 3-MCPD ester content is reduced to 1.9 ppm.

1. A method of producing a refined, bleached and deodorised vegetable oil which comprises degumming a vegetable oil, bleaching the degummed oil and deodorising the bleached oil, wherein the degumming, bleaching and deodorising conditions are selected to reduce the content of 3-chloropropane-1,2-diol and esters thereof in the deodorised oil to less than 8 ppm.

2. A method of reducing the content of 3-chloropropane-1,2-diol and esters thereof of in a refined, bleached and deodorised vegetable oil, which comprises degumming a vegetable oil, bleaching the degummed oil and deodorising the bleached oil, wherein at least one of the degumming, bleaching and deodorising conditions are selected to reduce the content of 3-chloropropane-1,2-diol and esters thereof in the deodorised oil to less than 8 ppm.

3. Method as claimed in claim 2, wherein the vegetable oil comprises palm oil or a fraction thereof.

4. Method as claimed in claim 3, wherein the degumming is carried out using a degumming agent comprising citric acid.

5. Method as claimed in claim 4, wherein the degumming agent comprises a mixture of citric acid and phosphoric acid.

6. Method as claimed in claim 5, wherein deodorisation is carried out at a temperature of less than 260° C.

7. Method as claimed claim 5, wherein deodorisation is carried out at a temperature of from 180° C. to 255° C.

8. Method as claimed in claim 7, wherein bleaching is carried out using a natural, non-activated bleaching agent.

9. Method as claimed in claim 8, wherein the content of 3-chloropropane-1,2-diol and esters thereof in the deodorised oil is reduced to less than 4 ppm.

10. Method as claimed in claim 8, wherein the content of 3-chloropropane-1,2-diol and esters thereof in the deodorised oil is reduced to less than 2 ppm.

11. Non-interesterified, refined, bleached, degummed and deodorised palm oil, or a fraction thereof, having a content of 3-chloropropane-1,2-diol and esters thereof of less than 8 ppm.

12. Palm oil or fraction thereof as claimed in claim 11 having a content of 3-chloropropane-1,2-diol and esters thereof of less than 4 ppm.

13. Palm oil or fraction thereof as claimed in claim 11 having a content of 3-chloropropane-1,2-diol and esters thereof of less than 2 ppm.

14. Food product comprising a palm oil or fraction thereof according to claim 11.
